(19) United States
(12) Patent Application Publication
(10) Pub. No.: US 2026/0128953 A1
(43) Pub. Date: May 7, 2026

(54) METHODS FOR VFL OPERATION BY AF AS VFL SERVER VIA NEF IN 5GC

(71) Applicant: InterDigital Patent Holdings, Inc., Wilmington, DE (US)

(72) Inventors: Jung Je Son, Warrington, PA (US); Ulises Olvera-Hernandez, Saint-Lazare (CA); Michel Roy, Candiac (CA)

(73) Assignee: InterDigital Patent Holdings, Inc., Wilmington, DE (US)

(21) Appl. No.: 18/940,706

(22) Filed: Nov. 7, 2024

(51) Int. Cl. H04L 41/14; H04L 41/16; H04W 48/16

(52) U.S. Cl. CPC H04L 41/14; H04L 41/16; H04W 48/16

(57) ABSTRACT

A method implemented by a network device, including receiving analytic identification information Network Data Analytics Functions (NWDAFs) for Vertical Federate Learning (VFL) for an analytic identifier. Analytic identification information includes a VFL configuration identifier for the analytic identifier and a learning model (LM) identifier or feature identifier for the VFL configuration identifier for the analytic identifier. A candidate NWDAF for VFL training is determined for the VFL configuration identifier for the analytic identifier. A service response is sent and indicates the candidate NWDAF using a temporary identifier and the LM identifier or the feature identifier fort the VFL configuration identifier. A service request for VFL training is received and includes the analytic identifier, VFL configuration identifier, and VFL correlation identifier identifying the VFL training session between a VFL server and VFL client. An indication of completed VFL training is sent to the candidate NWDAF, and includes the VFL correlation identifier.

### BACKGROUND

Vertical Federated Learning (VFL) is a machine learning technique performed without exchanging and/or sharing local data sets while maintaining some level of coordination among VFL participants. For Vertical Federated Learning (VFL) operations, the VFL server may play an important role in coordinating model training of VFL clients in 5GC. Horizontal Federated Learning (HF) is an additional machine learning technique which may be utilized for training.

### SUMMARY

A network device may include a processor. The processor may be configured to receive analytic identification information from a plurality of Network Data Analytics Functions (NWDAFs). One or more of the plurality of NWDAFs may be configured for Vertical Federate Learning (VFL) for an analytic identifier, and the analytic identification information may include a VFL configuration identifier for the analytic identifier and at least one of a learning model (LM) identifier or a feature identifier associated with the VFL configuration identifier for the analytic identifier. A candidate NWDAF for VFL training may be determined out of the plurality of NWDAFs, and the candidate NWDAF may be configured for the VFL configuration identifier for the analytic identifier. A service response may be sent, and the service response may indicate the candidate NWDAF using a temporary identifier and one or more of the LM identifier or the feature identifier associated with the VFL configuration identifier. A service request to initiate VFL training may be received and the service request may include the analytic identifier, the VFL configuration identifier, and a VFL correlation identifier that identifies the VFL training session between a VFL server and a VFL client. An indication that indicates that VFL training is complete may be sent to the candidate NWDAF, and the indication may include the VFL correlation identifier.

The processor may be configured to assign a VFL client identifier to the candidate NWDAF, wherein VFL client identifier is valid during a VFL training session between an Application Function (AF) and the candidate NWDA.

The processor may be configured to send a service request for VFL client discovery from the AF, the service request comprising analytics service information comprising the analytic identifier and the VFL correlation identifier, and at least one of service area information or a time condition specific to a particular service area or time period.

The processor may be configured to receive a service request for VFL client discovery comprising a VFL correlation identifier; send, based on the service request, a request for a list of candidate NWDAFs that are configured for the VFL configuration identifier for the analytic identifier; and receive the list of the candidate NWDAFs from Network Function (NF) profiles of the candidate NWDAFs upon an indication that the VFL correlation identifier is included in the NF profiles of the candidate NWDAFs.

The processor may be configured to request additional information from the NWDAFs identified from the NF profiles and to verify whether the additional information includes the VFL correlation identifier.

The processor may be configured to select the candidate NWDAF configured for the VFL correlation identifier based on the additional information received from each NWDAF, and assign a VFL client identifier to each selected NWDAF, wherein each VFL client identifier is valid for a VFL inference session between an Application Function (AF) and the selected NWDAFs, and wherein each VFL client identifier is used to anonymize the identification information of each NWDAF from the AF.

The processor may be configured to determine intermediate model training results comprising at least one of gradient information or loss information from the candidate NWDAF.

The processor may be configured to receive a service request for VFL client discovery that comprises a VFL correlation identifier for an analytic identifier; send a request for a list of NWDAFs from the plurality of NWDAFs that are configured for a configuration identifier for the analytic identifier; and receive the list of NWDAFs that are configured for the VFL configuration identifier for the analytic identifier based on the VFL correlation identifier.

The processor may be configured to send an additional service response for VFL client discovery, the additional service response comprising a list of candidate NWDAFs represented by temporary identifiers and additional information for each of the candidate NWDAFs, the additional information comprising one or more of an LM identifier or a feature identifier.

The processor may be configured to select one or more candidate NWDAFs from the list of candidate NWDAFs based on at least one of the LM identifier or the feature identifier from the additional information for the each of the candidate NWDAFs to perform VFL inference using a trained machine learning model associated with the VFL correlation identifier.

Methods implemented by a network device may be described herein. The method may include receiving analytic identification information from a plurality of Network Data Analytics Functions (NWDAFs). One or more of the plurality of NWDAFs may be configured for Vertical Federate Learning (VFL) for an analytic identifier, and the analytic identification information may include a VFL configuration identifier for the analytic identifier and at least one of a learning model (LM) identifier or a feature identifier associated with the VFL configuration identifier for the analytic identifier. A candidate NWDAF for VFL training may be determined out of the plurality of NWDAFs, and the candidate NWDAF may be configured for the VFL configuration identifier for the analytic identifier. A service response may be sent, and the service response may indicate the candidate NWDAF using a temporary identifier and one or more of the LM identifier or the feature identifier associated with the VFL configuration identifier. A service request to initiate VFL training may be received and the service request may include the analytic identifier, the VFL configuration identifier, and a VFL correlation identifier that identifies the VFL training session between a VFL server and a VFL client. An indication that indicates that VFL training is complete may be sent to the candidate NWDAF, and the indication may include the VFL correlation identifier.

The method may include assigning a VFL client identifier to the candidate NWDAF, wherein VFL client identifier is valid during a VFL training session between an Application Function (AF) and the candidate NWDA.

The method may include sending a service request for VFL client discovery from the AF, the service request comprising analytics service information comprising the analytic identifier and the VFL correlation identifier, and at least one of service area information or a time condition specific to a particular service area or time period.

The method may include receiving a service request for VFL client discovery comprising a VFL correlation identifier; sending, based on the service request, a request for a list of candidate NWDAFs that are configured for the VFL configuration identifier for the analytic identifier; and receiving the list of the candidate NWDAFs from Network Function (NF) profiles of the candidate NWDAFs upon an indication that the VFL correlation identifier is included in the NF profiles of the candidate NWDAFs.

The method may include requesting additional information from the NWDAFs identified from the NF profiles and to verify whether the additional information includes the VFL correlation identifier.

The method may include selecting the candidate NWDAF supporting the VFL correlation identifier based on the additional information received from each NWDAF, and assign a VFL client identifier to each selected NWDAF, wherein each VFL client identifier is valid for a VFL inference session between an Application Function (AF) and the selected NWDAFs, and wherein each VFL client identifier is used to anonymize the identification information of each NWDAF from the AF.

The method may include determining intermediate model training results comprising at least one of gradient information or loss information from the candidate NWDAF.

The method may include receiving a service request for VFL client discovery that comprises a VFL correlation identifier for an analytic identifier; sending a request for a list of NWDAFs from the plurality of NWDAFs that are configured for a configuration identifier for the analytic identifier; and receiving the list of NWDAFs that are configured for the VFL configuration identifier for the analytic identifier based on the VFL correlation identifier.

The method may include sending an additional service response for VFL client discovery, the additional service response comprising a list of candidate NWDAFs represented by temporary identifiers and additional information for each of the candidate NWDAFs, the additional information comprising one or more of an LM identifier or a feature identifier.

The method may include selecting one or more candidate NWDAFs from the list of candidate NWDAFs based on at least one of the LM identifier or the feature identifier from the additional information for the each of the candidate NWDAFs to perform VFL inference using a trained machine learning model associated with the VFL correlation identifier.

For VFL model configuration negotiation, VFL server and VFL clients may include a preconfigured VFL configuration represented by a VFL configuration ID. VFL clients may be configured to support a local ML model with an associated feature set which may be represented with Local Model ID/Feature ID.

A VFL server may gather additional information from VFL clients and select proper VFL clients for VFL training.

After VFL training, NEF and VFL clients may store the list of NWDAF and VFL configuration ID.

For VFL inference, NEF may discover VFL clients for inference using the additional information from VFL clients.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram 200 illustrating an example reference model for a 5G and/or NextGen network architecture.

FIG. 3 is a diagram 300 illustrating examples of Horizontal Federated Learning (HFL) and Vertical Federated Learning (VFL).

FIGS. 4A and 4B show a diagram 400 illustrating an example Vertical Federate Learning (VFL) Procedure with AF as a VFL server via NEF.

FIGS. 5A and 5B show a diagram 500 illustrating an example VFL inference Procedure with AF as VFL server via NEF.

### DETAILED DESCRIPTION

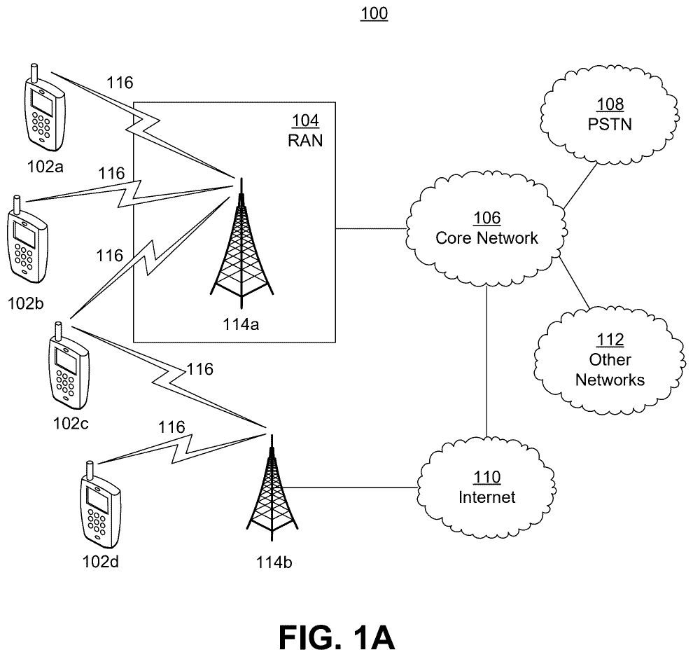

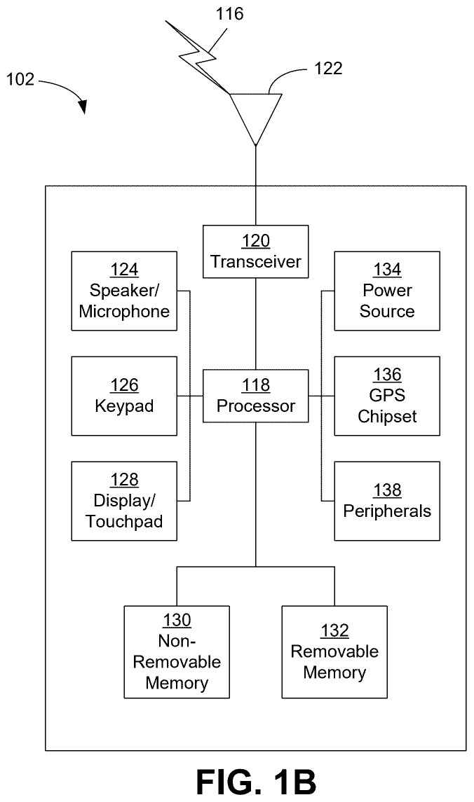

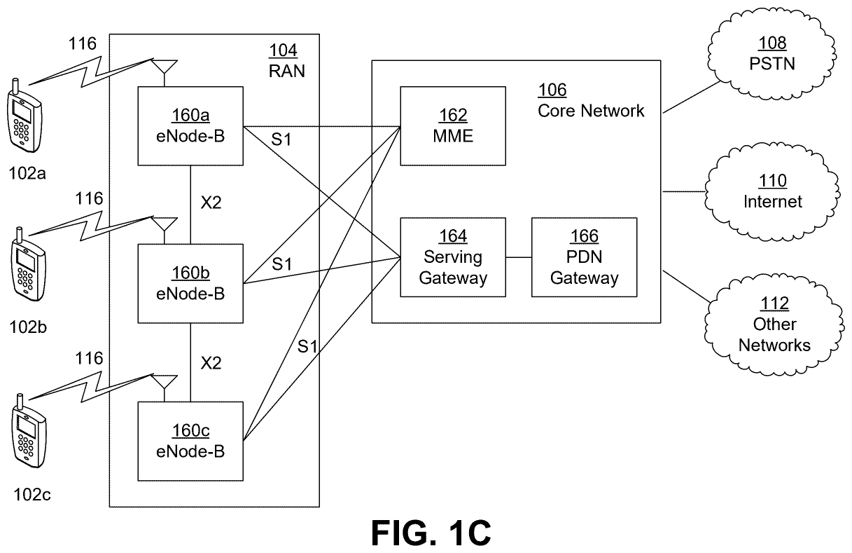

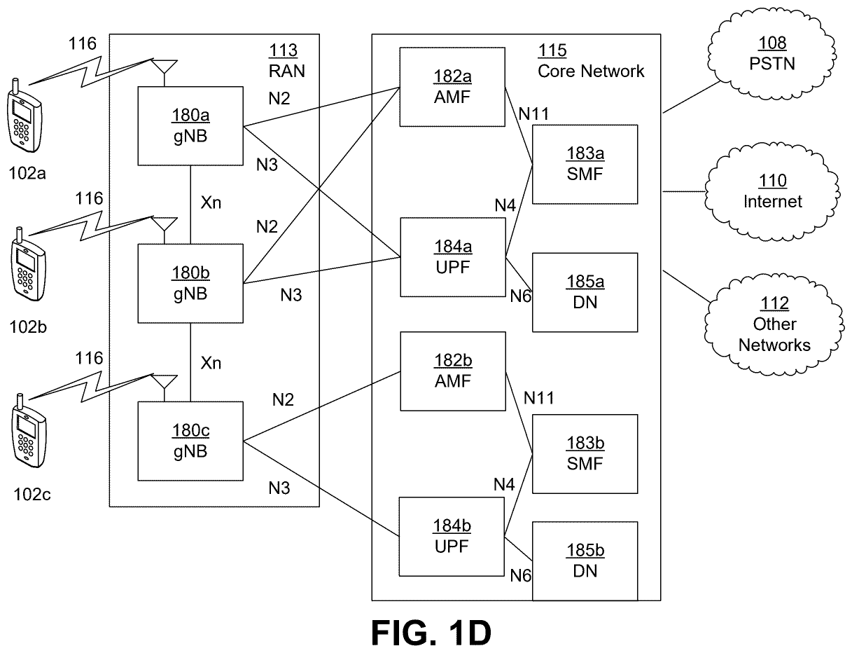

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

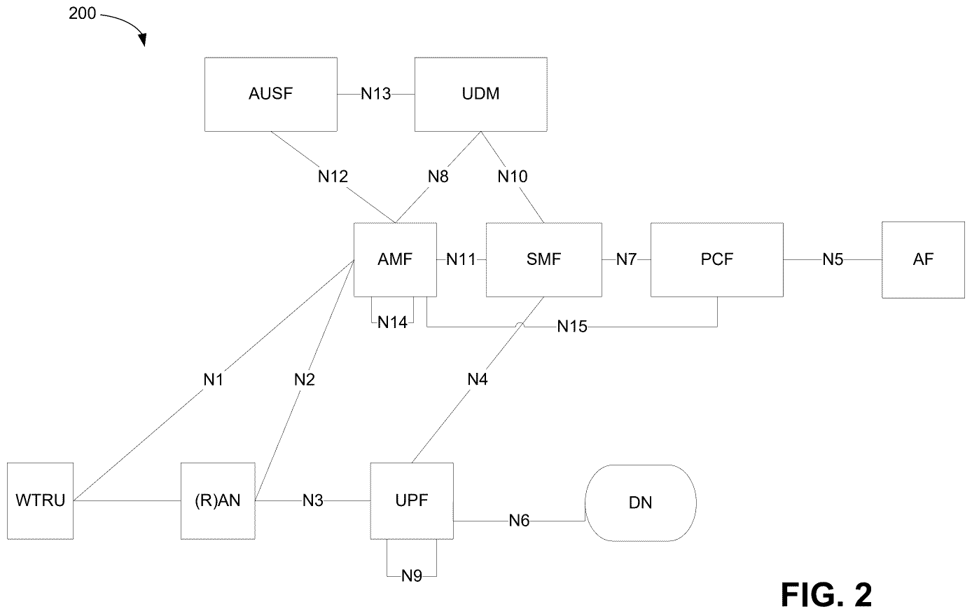

FIG. 2 is a diagram 200 illustrating an example reference model for a 5G and/or NextGen network architecture. In this context, RAN refers to a radio access network based on the 5G RAT and/or Evolved E-UTRA that may connect to the NextGen core network.

For VFL Training and Inference with an AF as a VFL Server via NEF, an NEF may discover VFL clients using a requested analytic ID and VFL configuration ID. The NEF may collect additional information, which may include the supported LM ID and/or Feature ID per VFL configuration ID, from each VFL client and send this collected information to the VFL server along with a temporary ID of NWDAFs as VFL clients. During VFL training, the NEF may transfer signaling messages between the VFL server and VFL clients. When the NEF receives an indication of VFL training completion, it may store the information of the NF ID of NWDAFs as VFL clients per VFL correlation ID. Upon receiving a VFL client discovery request using the VFL correlation ID for VFL inference, the NEF may retrieve the NF ID information of NWDAFs as VFL clients per VFL correlation ID. Additionally, the NEF may collect further information, including the supported LM ID and/or Feature ID per VFL correlation ID, and send this information to the VFL server with the temporary ID of NWDAFs as VFL clients. During VFL inference, the NEF may transfer signaling messages between the VFL server and VFL clients.

In examples, the Access Control and Mobility Management Function (AMF) may include functionalities for registration management, connection management, reachability management, and/or mobility management. The Session Management Function (SMF) may include functionalities for session management (e.g., session establishment, modify and/or release), WTRU IP address allocation, and/or the selection and control of the UP function. The User Plane Function (UPF) may include functionalities such as packet routing and forwarding, packet inspection, and/or traffic usage reporting.

The Network Data Analytics service may provide statistics and/or predictions based on specific requests from the entities consuming this information. Information provided by the Network Data Analytics service may include statistics and predictions regarding gNB status information, gNB resource usage, communication, and/or mobility performance within an Area of Interest. Targets of such analytics may include, for example, a single WTRU, a group of WTRUs, and/or any WTRU located in an Area of Interest. Furthermore, the Network Data Analytics service may provide analysis on statistics and/or predictions regarding WTRU mobility, expected WTRU behavior, and/or observed service experience at multiple levels (e.g., per NW slice, per application, and/or per access type).

The Network Data Analytics service may be provided by the Network Data Analytics Function (NWDAF) in the 5G Core (5GC). The NWDAF may register to a Network Repository Function (NRF) its supported Analytics ID, per service, which may indicate a kind of network data analytics service, such as slice load level related network data analytics, observed service experience related network data analytics, and/or Federated Learning amongst multiple NWDAFs).

The NWDAF may contain various functions such as an Analystics Logical Function (AnLF) and/or a Model Training Logical Function (MTLF). The AnLF may be a logical function in NWDAF that may perform inference, derive analytics information (e.g., deriving statistics and/or predictions based on an Analytics Consumer request), and/or expose analytics services. The MTLF may be a logical function in NWDAF that may train Machine Learning (ML) models and expose new training services (e.g., providing a trained ML model). The NWDAF (MTLF) may provide trained ML models to the AnLF. The NWDAF may also decide whether to use horizontal or vertical federated learning for training ML models.

Federated learning among multiple NWDAFs may be specific by 3GPP, and may specify how NWDAF functions, including the model training function, may leverage federated learning techniques to train an ML model. For Horizontal Federated Learning (HFL), each NWDAF function enabled for federated learning may register to the Network Repository Function (NRF) with its NF profile, information for supported analytic services (e.g., Analytics ID(s)), address information of NWDAF, Service Area, and/or capability for Federated Learning (e.g., as a VFL server and/or as a VFL client). This registered information may be utilized to find proper NWDAF functions to join federated learning for some analytics services with candidate ML models and/or requested service areas.

Model Filter information may be defined to indicate the conditions when an ML model is requested for analytics services and/or a target of the ML model, such as specific WTRU(s), groups of WTRUs, and/or any WTRU.

In HFL, an FL Server NWDAF and/or an FL Client NWDAF may be defined. When an analytic service is requested, federated learning may be requested, for example, to a FL Server NWDAF with ML model accuracy. The FL Server NWDAF may then discover and/or select a proper FL Client NWDAF for the specified analytics service with the requested ML model at some service area and/or NF types of data sources from which NWDAF may collect data for local model training, and/or an interested time period. The FL Server NWDAF may provide the FL Client NWDAF with the local ML model and request for the FL Client NWDAF to perform the local model training. Each FL Client NWDAF may collect its local data, perform local model training with its data, and/or report the interim local ML model information to the FL Server NWDAF. The FL Server NWDAF may update the global ML model based on the aggregated local ML models and may provide the proper global ML model for the requested analytics service.

Vertical Federated Learning (VFL) is a machine learning technique performed without exchanging and/or sharing local data sets while maintaining some level of coordination among VFL participants. Training and/or inference may be performed on local ML models. The local data sets in different VFL participants for local model training may have different feature spaces for the same samples (e.g., WTRU IDs). Vertical Federated Learning may involve multiple NWDAFs and/or Application Functions (AFs)AF.

A feature space may use an ML model specific to a feature space and may utilize a data set that is also specific to that feature space and/or to the ML model used in that feature space.

Different feature spaces may be used when performing VFL. Each feature space may utilize a different ML model that is feature space specific, and consequently each feature space may utilize a feature space specific data set.

Sample alignment may be necessary to perform between the feature spaces. The sample alignment may include determining common attributes to be considered while performing VFL in the different feature spaces. For example, if VFL is performed in a mobile network, each feature space may perform in VFL using their own ML models and/or data sets for a specific group of WTRUs, which may necessitate a sample alignment based on WTRU identifiers. Other examples of sample alignment may include time periods, geographical locations, a determined portion of a network (e.g., a list of TAs), functional elements of a network (e.g., an AMF, an SMF, and/or a list of UPFs. The sample alignment information may be communicated to each feature space and each feature space may consider the sample alignment information to determine the data set for performing VFL.

For Vertical Federated Learning, there may be one NWDAF and/or one AF acting as a VFL server and/or one or multiple NWDAFs and/or one or multiple AFs acting as VFL clients. Example functionalities of VFL servers and VFL clients are described herein below.

A VFL server may discover and/or select VFL clients (e.g., NWDAFs and/or AFs) to participate in a VFL procedure, and/or may request VFL clients to perform local ML model training for an Analytic Identifier (ID). A VFL server may aggregate intermediate results from VFL clients and may compute intermediate training results (e.g., gradient information and/or loss information) for updating its own local ML model and/or the ML models of the VFL clients during the VFL training process. The intermediate training results may be sent to one or more VFL clients involved in the joint VFL training process. A VFL server may initiate a VFL inference process using a VFL model correlation ID, aggregate local inference results from VFL clients, generate a final VFL inference result, and/or send the final inference result to the consumer.

A VFL client may perform various functions, including locally training ML models with an available local data set, which may include data that may be not desired and/or not allowed to be shared with other VFL clients due to, for example, data privacy, data security, and/or data access rights. A VFL client may determine intermediate results for their local ML models involved in the VFL training and/or may provide reports with the intermediate results to the AF and/or NWDAF acting as a VFL server. A VFL client may determine inference results by performing inference based on the local model and/or local data. The determined inference results may be sent by the VFL client to the VFL server.

VFL is a federated learning method which enables performing joint training without exposing raw data, with each entity owning its own model. In VFL, multiple parties may perform training on one or more data sets that may share the same sample space but may differ in the feature space, which may necessitate an alignment in sample and feature spaces among participating entities before applying VFL.

A 5GC may provide observed service experience analytics by using VFL procedures. For observed service experience analytics service by NWDAF, data may need to be collected from various sources for each WTRU included in the procedure. For example, service quality and/or service experience data may be needed from the AF as input data, network data in QoS flow levels may be needed rom the 5GC NF as input data, and/or WTRU level Network (NW) data relating to the QoS profile may be needed from an OAM.

When a NWDAF and/or an AF initiates the VFL training process for observed service experience analytics, it may be desired that no exchange of raw data take place directly between the NWDAF and an external AF, as NWDAF may be in the PLMN and the AF may be outside the PLMN. This condition may compromise user data which may have high privacy protection requirements.

NWDAF and AF may have different features of the same sample identity for local training, and thus, the application of VFL among two entities may necessitate alignment of samples and/or features. Additionally, and/or alternatively, when NWDAFs from different vendors are involved together for VFL, for each feature, alignments may be necessary to perform among NWDAFs for how features are defined, measured, and/or presented. The VFL server may aggregate the results from VFL clients and/or apply the results to learn the global ML model.

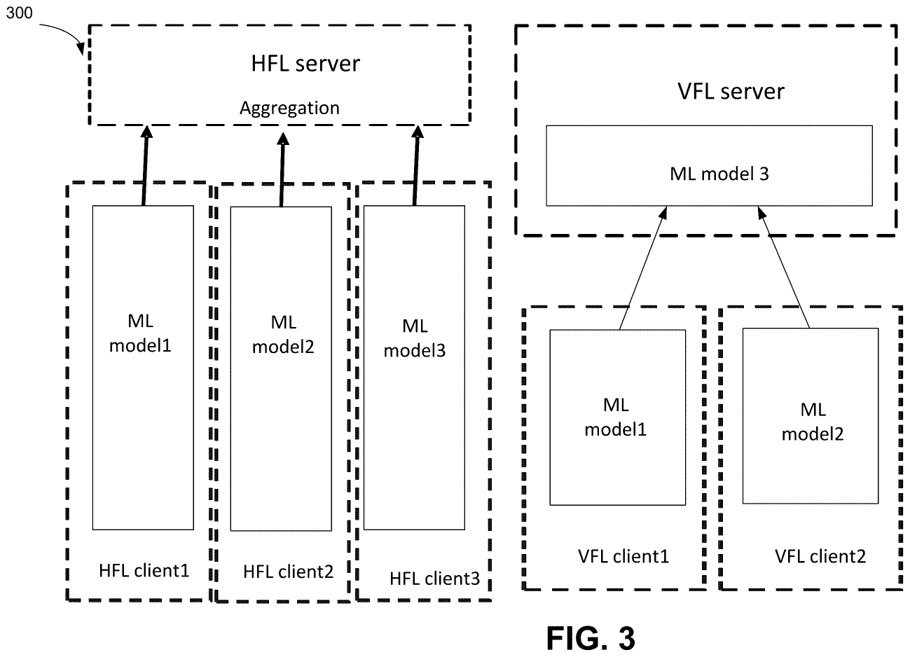

FIG. 3 is a diagram 300 illustrating examples of Horizontal Federated Learning (HFL) and Vertical Federated Learning (VFL). Various differences may be identified between HFL and VFL when applied at a network analytic service in the 5G Core (5GC).

For Horizontal Federated Learning (HFL) in 5GC, the entities involved may be within the same operator's control. It may be assumed that for each analytic service, which may be identified by an Analytic Identifier (ID), NWDAFs may be preconfigured with supported ML models by operators and/or NWDAF supporting the same Analytic ID may be capable of supporting the same ML model. Compatibility of specific file formats and/or environments for ML models from a different vendor can be verified based on interoperability information when NWDAFs from different vendors are involved. For Vertical Federated Learning in the 5GC, both AF and NWDAF may be involved and the supported ML models per Analytic ID may be different between the AF and NWDAFs when the AF is out of control of the operator.

For HFL in the 5GC, the same ML models with the same features but different sample sets may be used by FL client NWDAFs, and the same ground truth data may be available among FL client NWDAFs and FL server NWDAFs. However, for VFL training, ML models used by each FL client NWDAF may have different features but may have the same sample sets. The VFL server may build a global ML model by integrating the ML models from the VFL server and VFL clients. As a result, only the VFL server may acquire ground truth data for training the global ML model, and the availability of ground truth data for training local ML models may be different for different VFL cases.

For Vertical Federated Learning (VFL) operations, the VFL server may be utilized for coordinating ML model training among VFL clients, including, for example, sample alignment, intermediate result exchange, model updates, and/or privacy and security. However, when the AF is a third-party entity (e.g., a non-trusted entity), information sharing among participants, including NWDAFs as VFL clients, may be restricted. For example, NWDAF's ID information may not be shared with the AF to avoid sharing the operator's network deployment information, so the NEF may instead share temporary ID information of the NWDAF with the AF. As another example, the NF profile registered with the NRF to discover the proper NF may not be fully shared with the AF.

For VFL operations involving the AF as a VFL server, the AF as a VFL server, NWDAFs as VFL clients, and NEF may work together for VFL operation while minimizing information sharing between the AF and NWDAFs to avoid revealing operator network deployment information.

For VFL training operations, synchronization of ML model information and supported feature and sample information between the VFL server and VFL clients may be particularly useful. However, when the AF is a non-trusted entity, sharing this information between the AF and NWDAFs may not be possible or may be undesirable for the operator. Therefore, in examples, synchronization of ML model information between the AF and NWDAFs may occur without disclosing mobile operator network information.

VFL operation may support both VFL training and VFL inferencing, so the synchronization consideration may apply not only to VFL training but also to VFL inferencing. For VFL inferencing, the results of VFL training may be reused. Therefore, coordination among the AF, NWDAF, and NEF may support reusing of context for VFL training for VFL inferencing.

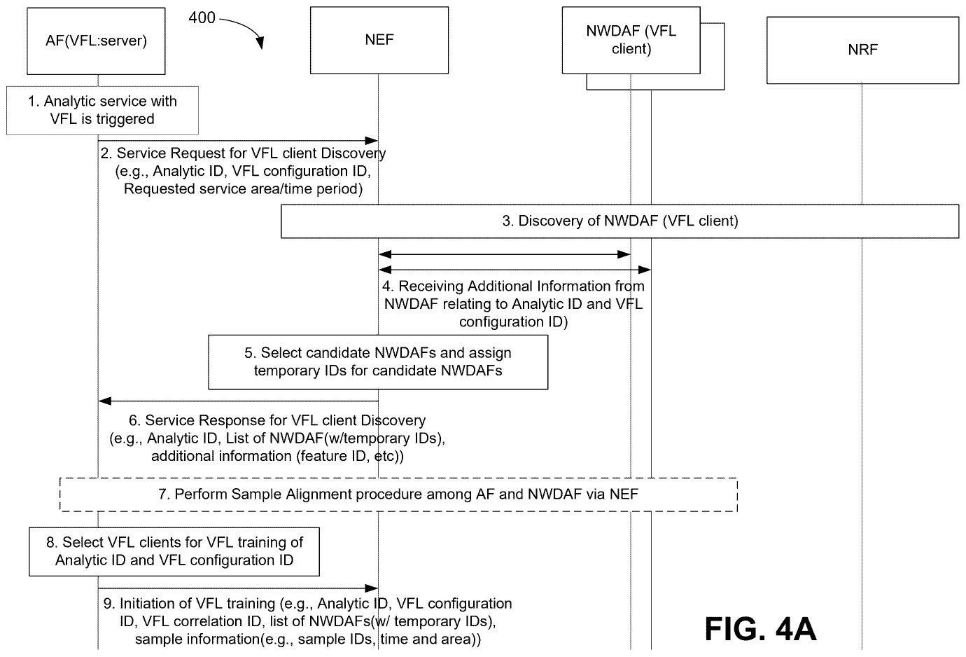

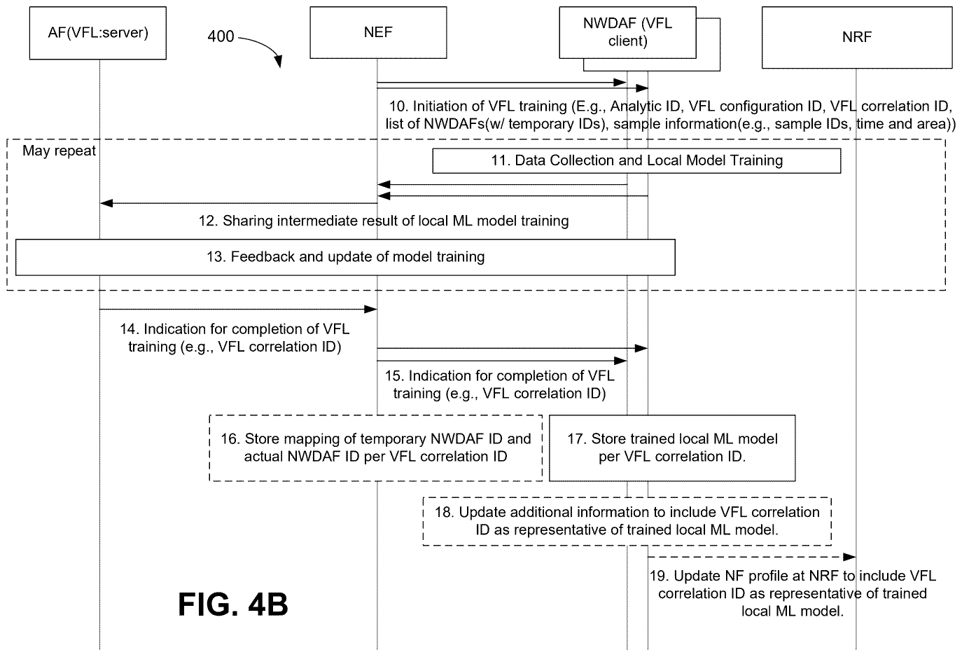

FIGS. 4A and 4B show a diagram 400 illustrating an example Vertical Federate Learning (VFL) Procedure with AF as a VFL server via NEF. For an Analytic ID, there may be various VFL configurations involving the AF and/or NWDAFs as VFL servers and/or VFL clients.

An example VFL configuration may include a number of VFL clients, a local ML model for each VFL client with a different feature set as input data, and/or methods by which local ML models may be integrated.

For each Analytic ID, the AF and NWDAF supporting VFL as VFL server and/or VFL clients may be preconfigured with some VFL configuration which may be represented by one or more VFL configuration IDs per analytic ID.

A VFL client which is preconfigured with a VFL configuration ID may support a local ML model of the VFL configuration with an associated feature set. A local ML model ID (LM ID) and/or a Feature ID may be allocated to indicate the supported local ML model and its associated feature set.

For example, a VFL configuration with a specific VFL configuration ID may involve five VFL clients, each with different local ML models. For each of the local ML models, a local ML model with a different feature set may be used. In this case, LM ID_1, LM ID_2, . . . , LM ID_5 and/or Feature ID_1, Feature ID_2, . . . , Feature ID_5 may be assigned to each local ML model with its associated feature set.

In block 1, the AF may be triggered to use Vertical Federated Learning (VFL) for an analytic service with the 5GC. The AF may be preconfigured with a VFL configuration for the analytic service, which may be represented by a VFL configuration ID. In block 2, the AF may send a service request for VFL client discovery, which may include Requested Analytics Service's information (e.g., an Analytic ID) and/or a VFL configuration ID. The AF may include Requested Service Area information and/or time conditions in the service request, if the requested analytic service and/or ML models are intended for a specific service area and/or time period.

In block 3, upon receiving the service request for VFL client discovery, the NEF may send a discovery request to the NRF to discover VFL clients supporting an Analytic ID and may receive a list of NWDAFs supporting VFL clients for the requested Analytic ID. In block 4, the NEF may then contact each discovered NWDAFs and receive additional information relating to the Analytic ID from each of the NWDAFs. Additional information may include supported VFL configuration ID information for the Analytic ID, LM ID and/or Feature ID) supported for the VFL configuration ID. In block 5, the NEF may then select NWDAFs supporting the appropriate VFL configuration for the Analytic ID as candidate NWDAFs. For each selected NWDAF, the NEF may assign a VFL client ID which may be valid at a VFL training session between the AF and discovered NWDAFs. A VFL client ID may be used to hide ID information of each NWDAF from AF. For each of the NWDAFs, additional information may be collected from NRF as another embodiment.

Additionally and/or alternatively, for each NWDAFs, additional information such as capacity, load information, computing power information, or energy consumption information (e.g., energy consumption efficiency, how much energy consumed, and/or energy source relating information) may be collected together from NRF or from each of the NWDAFs.

After VFL training completes, either successfully or in failure, the VFL client ID may not be valid anymore. For each VFL training session a different VFL client ID may be assigned to each NWDAF.

In block 6, after selecting candidate NWDAFs, the NEF may send a service response for VFL client discovery, which may include a list of candidate NWDAFs using temporary IDs and additional information about each NWDAF including LM ID and/or Feature ID. In block 7, the AF may then perform a sample alignment procedure with the NWDAFs via the NEF. In block 8, based on the additional information received and/or the results of the sample alignment, the AF may select a final list of NWDAFs to perform VFL training based on the VFL configuration information for the VFL configuration ID. For example, AF may select a NWDAF for each LM ID or Featured ID which may be configured for a VFL configuration ID based on additional information, such as energy consumption information and/or load information. If any VFL clients are missing from the requested feature set for the VFL configuration ID, the AF may request another service request for discovery of additional NWDAFs.

The AF may include a requested LM ID and/or Feature ID in in a service request for VFL client discovery. When a requested LM ID and/or Feature ID is included, the NEF may select NWDAFs supporting the VFL configuration ID with the requested LM ID and/or Feature ID from the discovered NWDAFs and report the list of NWDAFs to the AF. A VFL client may register its supported VFL configuration IDs for each Analytic ID when it registers its capability as a VFL client with the NRF. When the NEF receives the list of NWDAFs supporting VFL client functionality for the requested Analytic ID from the NRF, it may also receive supported VFL configuration IDs for an analytic ID of each NWDAF. An NEF may receive supported LM ID and/or Feature ID information for each supported VFL configuration ID from the NRF.

In block 9, the AF may initiate VFL by sending a service request for initiating VFL training. This service request may include the requested Analytic ID, VFL configuration ID, and a VFL correlation ID, which may identify the VFL training session between the VFL server and VFL clients using the VFL configuration ID for the Analytic ID and the list of NWDAFs with temporary IDs provided by the NEF. The service request may also include sample information, such as sample IDs and conditions for data collection, such as time and service area. In block 10, upon receiving this service request, the NEF may forward the service request to the NWDAFs included in the list of NWDAFs using a temporary ID and/or the NEF may identify a real ID of an NWDAF from the temporary ID.

In block 11, as may be requested by the AF, each NWDAF acting as a VFL client may perform local data collection for the feature configured by the LM ID and/or Feature ID of the VFL configuration ID from samples and perform local ML model training using the collected data. In block 12, each NWDAF may share the intermediate result of the local ML model training. In block 13, based on the interim results collected from NWDAFs, the AF may train the overall ML model, update the local ML model, and/or provide feedback to each NWDAF. Until the ML model training is successfully completed, this cycle of data collection, local training, result sharing, and feedback may be iteratively repeated.

In block 14, after completing the VFL-based ML model training, the AF may send an indication of VFL training completion, including the VFL correlation ID. In block 15, the NEF may then forward the indication to each NWDAF, including the VFL correlation ID. Upon receiving the indication, the NEF may store the list of NWDAFs involved in the VFL training, along with the VFL correlation ID and/or the VFL client ID of each NWDAF used during the VFL training session, together.

In block 16, upon receiving the completion indication, each NWDAF may store the trained local ML model per the VFL correlation ID. Each NWDAF may also update additional information to include the VFL correlation ID as a representative of the trained local ML model, along with the LM ID and/or Feature ID and, optionally, the VFL configuration ID. Each NWDAF may update its NF profile at the NRF to include the VFL correlation ID, representative of the trained local ML model supported by the NWDAF as a VFL client.

In examples, the AF as the VFL server and/or NWDAFs as VFL clients may manage a timer associated with the validity period of the VFL correlation ID. During this period, the AF may use the trained ML model associated with the VFL correlation ID for VFL inference. When the timer expires, NWDAFs may discard the locally trained ML model associated with the VFL correlation ID. If the AF requests a VFL inference using the VFL correlation ID after the timer expires, NWDAFs may reject the request with a reason code indicating that no locally trained ML model exists.

In block 17, the NWDAFs may store the trained local ML model associated with the VFL correlation ID on a server or NF. In block 18, after storing the trained local ML model, the NWDAF may retrieve the stored trained local ML model associated with the VFL correlation ID if the NWDAF does not have a locally stored ML model associated to a VFL correlation ID or after a timer relating to VFL correlation ID expires.

In block 19, the NEF may manage a timer relating to a stored list of NWDAFs associated with the VFL correlation ID. Upon the timer's expiration, the NEF may discard the stored list of NWDAFs associated with the VFL correlation ID. Additionally and/or alternatively, the NEF may store the list of NWDAFs associated with the VFL correlation ID on a server or NF. After storing the list, the NEF may retrieve the stored list of NWDAFs when receiving a service request from the AF relating to a VFL correlation ID.

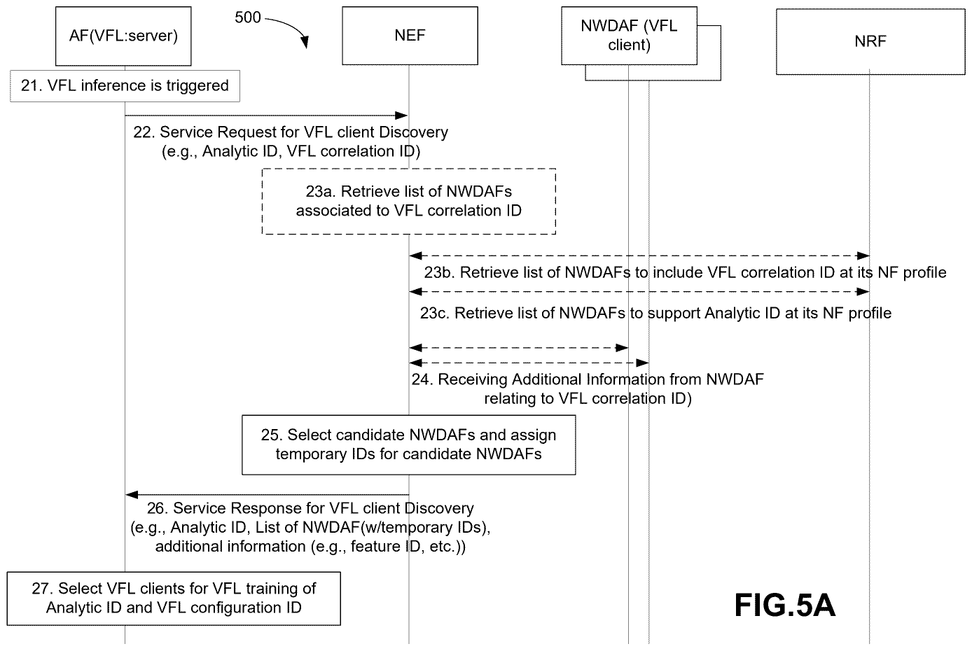

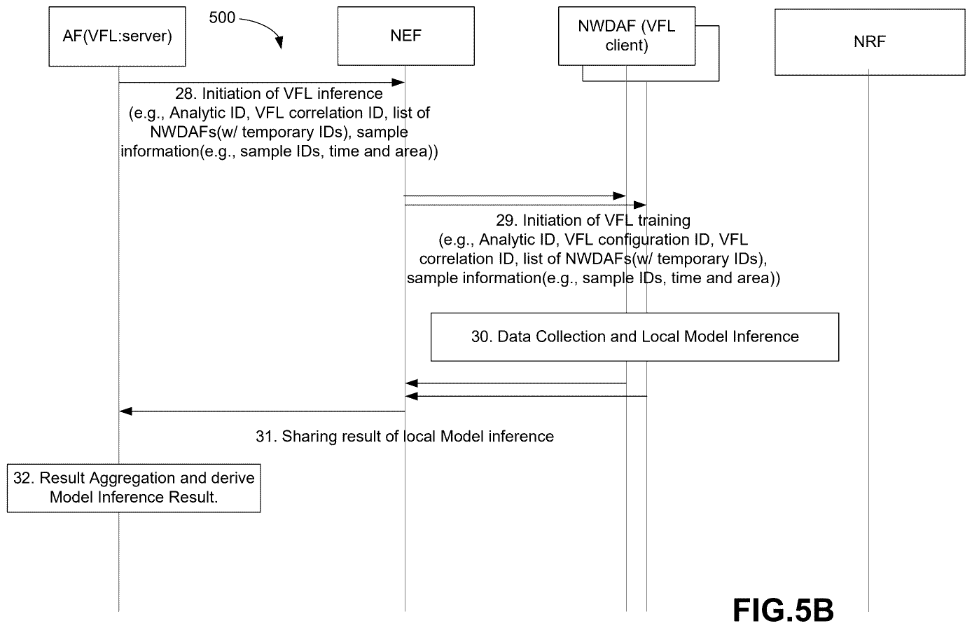

FIGS. 5A and 5B show a diagram 500 illustrating an example VFL inference Procedure with AF as VFL server via NEF.

In block 21, the AF as the VFL server may be triggered to perform VFL inference for an Analytic ID and the AF may decide to use a trained ML model for the Analytic ID, which may be represented by the VFL correlation ID. In block 22, the AF may send a service request for VFL client discovery, which may include Requested Analytics Service's information (e.g., an Analytic ID) and/or a VFL correlation ID. The AF may include Requested Service Area information and/or time conditions in the service request. If the requested analytic service is intended for a specific service area or time period, the AF may also include requested service area information and/or time conditions in the service request.

In block 23a, after receiving the service request for VFL client discovery using the VFL correlation ID, the NEF may retrieve the list of NWDAFs associated with the VFL correlation ID if this information for the Analytic ID exists in locally stored data. In block 23b, if the list is not available, the NEF may request a list of NWDAFs supporting the Analytic ID from the NRF and collect the list of NWDAFs supporting the VFL correlation ID if the VFL correlation ID is included in the NWDAF's NF profile managed by the NRF.

In block 23c, after receiving the service request for VFL client discovery using a VFL correlation ID, the NEF may request a list of NWDAFs supporting the Analytic ID and collect a list of NWDAFs that support VFL client capability for the Analytic ID. For each NWDAFs, additional information for example capacity, load information, computing power information, or energy consumption information (energy consumption efficiency, how much energy consumed, and/or energy source relating information) may be collected together.

In block 24, the NEF may then contact the NWDAFs, which may be discovered through any of the above described methods and may receive additional information from the NWDAFs, checking whether the additional information includes the VFL correlation ID. In block 25, Based on the results, the NEF may select candidate NWDAFs supporting the VFL correlation ID and assign a VFL client ID for each NWDAF which are valid at a VFL inference session between the AF and discovered NWDAFs using the VFL correlation ID. The VFL client ID may be used to hide ID information of each NWDAF from the AF. Once VFL inference is completed, the VFL client ID may not be valid anymore. For each new VFL inferencing session a different VFL client ID may be assigned to each NWDAF.

In block 26, the NEF may then send a service response for VFL client discovery, which may include a list of candidate NWDAFs using temporary IDs and additional information of each NWDAF, such as LM ID and/or Feature ID. In block 27, based on this additional information, the AF may determine a final list of NWDAFs from a list of candidate NWDAFs to perform VFL inference using the trained ML model represented by the VFL correlation ID. For example, the AF may select a NWDAF to comply with each LM ID configured for the VFL correlation ID for example based on additional information such as load information, capacity information, and/or energy consumption information. In block 28, the AF may then send a service request to initiate VFL inference, which may include the Analytic ID, VFL correlation ID, and a list of NWDAFs using temporary IDs assigned by the NEF. The service request may also include sample information, such as sample IDs and conditions for collecting data such as time and/or service area.

In block 29, upon receiving the service request for initiating VFL inference, the NEF may forward the service request to the NWDAFs included in the list of NWDAFs using temporary ID to identify the real ID of each NWDAF from the temporary ID. In block 30, after receiving the service request for VFL inference, each NWDAF may collect data and perform local model inference using the trained local ML model associated with the VFL correlation ID. In block 31, the NWDAF may share the result of the local inference with the AF via the NEF. In block 32, he AF may then aggregate the local inference results to determine a final inference result.

The AF may send a service request for initiating VFL inference without first performing a service request for VFL client discovery. This service request may include a list of NWDAFs using VFL client IDs that were used during the VFL training session associated with the VFL correlation ID. When the NEF receives a service request for initiating VFL inference without performing steps for VFL client discovery, the NEF may verify whether it has a stored list of NWDAFs and VFL client IDs corresponding to each NWDAF. The NEF may then retrieve the list of NWDAFs associated with the VFL correlation ID, using the NWDAF ID corresponding to the VFL client ID of each NWDAF as provided by the AF. The NEF may forward the service request for VFL inference to each NWDAF associated with the VFL correlation ID.

If the NEF receives a service request for initiating VFL inference without performing steps for VFL client Discovery and/or if the NEF does not have a stored list of NWDAFs associated with the VFL correlation ID upon receiving the service request for initiating VFL inference, the NEF may respond to the AF with a reject code indicating no context (e.g., list of NWDAFs) for the VFL correlation ID, and the AF may send a service request for VFL client discovery.

In an example, if the NEF receives a service request for initiating VFL inference without performing steps for VFL client discovery and/or the NEF does not have a stored list of NWDAFs associated to a VFL correlation ID, does not have a stored list of NWDAFs associated with the VFL correlation ID, the NEF may perform discovery of NWDAFs associated with the VFL correlation ID and/or collect additional information of the NWDAFs relating to the VFL correlation ID as described above. The NEF may then select a list of NWDAFs for VFL inference associated with the VFL correlation ID, assign a VFL client ID to each selected NWDAF, and/or report the selected list of NWDAFs with VFL client IDs associated with the VFL correlation ID. The AF may send a VFL inference using the selected NWDAFs.

1. A network device comprising:
a processor configured to:
receive analytic identification information from a plurality of Network Data Analytics Functions (NWDAFs), wherein one or more of the plurality of NWDAFs are configured for Vertical Federate Learning (VFL) for an analytic identifier, and wherein the analytic identification information comprises a VFL configuration identifier for the analytic identifier and at least one of a learning model (LM) identifier or a feature identifier associated with the VFL configuration identifier for the analytic identifier;
determine a candidate NWDAF for VFL training out of the plurality of NWDAFs, wherein the candidate NWDAF is configured for the VFL configuration identifier for the analytic identifier;
send a service response, wherein the service response indicates the candidate NWDAF using a temporary identifier and one or more of the LM identifier or the feature identifier associated with the VFL configuration identifier;
receive a service request to initiate VFL training, the service request comprising the analytic identifier, the VFL configuration identifier, and a VFL correlation identifier that identifies the VFL training session between a VFL server and a VFL client; and
send an indication that indicates that VFL training is complete to the candidate NWDAF, wherein the indication comprises the VFL correlation identifier.

2. The network device of claim 1, wherein the processor is further configured to assign a VFL client identifier to the candidate NWDAF, wherein VFL client identifier is valid during a VFL training session between an Application Function (AF) and the candidate NWDAF.

3. The network device of claim 2, wherein the processor is further configured to send a service request for VFL client discovery from the AF, the service request comprising analytics service information comprising the analytic identifier and the VFL correlation identifier, and at least one of service area information or a time condition specific to a particular service area or time period.

4. The network device of claim 1, wherein the processor is further configured to:
receive a service request for VFL client discovery comprising a VFL correlation identifier;
send, based on the service request, a request for a list of candidate NWDAFs that are configured for the VFL configuration identifier for the analytic identifier; and
receive the list of the candidate NWDAFs from Network Function (NF) profiles of the candidate NWDAFs upon an indication that the VFL correlation identifier is included in the NF profiles of the candidate NWDAFs.

5. The network device of claim 4, wherein the processor is further configured to request additional information from the NWDAFs identified from the NF profiles and to verify whether the additional information includes the VFL correlation identifier.

6. The network device of claim 5, wherein the processor is further configured to select the candidate NWDAF configured for the VFL correlation identifier based on the additional information received from each NWDAF, and assign a VFL client identifier to each selected NWDAF, wherein each VFL client identifier is valid for a VFL inference session between an Application Function (AF) and the selected NWDAFs, and wherein each VFL client identifier is used to anonymize the identification information of each NWDAF from the AF.

7. The network device of claim 1, wherein the processor is further configured to determine intermediate model training results comprising at least one of gradient information or loss information from the candidate NWDAF.

8. The network device of claim 1, wherein the processor is further configured to:
receive a service request for VFL client discovery that comprises a VFL correlation identifier for an analytic identifier;
send a request for a list of NWDAFs from the plurality of NWDAFs that are configured for a configuration identifier for the analytic identifier; and
receive the list of NWDAFs that are configured for the VFL configuration identifier for the analytic identifier based on the VFL correlation identifier.

9. The network device of claim 1, wherein the processor is further configured to send an additional service response for VFL client discovery, the additional service response comprising a list of candidate NWDAFs represented by temporary identifiers and additional information for each of the candidate NWDAFs, the additional information comprising one or more of an LM identifier or a feature identifier.

10. The network device of claim 9, wherein the processor is further configured to select one or more candidate NWDAFs from the list of candidate NWDAFs based on at least one of the LM identifier or the feature identifier from the additional information for the each of the candidate NWDAFs to perform VFL inference using a trained machine learning model associated with the VFL correlation identifier.

11. A method implemented by a network device, the method comprising:
receiving analytic identification information from a plurality of Network Data Analytics Functions (NWDAFs), wherein one or more of the plurality of NWDAFs are configured for Vertical Federate Learning (VFL) for an analytic identifier, and wherein the analytic identification information comprises a VFL configuration identifier for the analytic identifier and at least one of a learning model (LM) identifier or a feature identifier associated with the VFL configuration identifier for the analytic identifier;
determining a candidate NWDAF for VFL training out of the plurality of NWDAFs, wherein the candidate NWDAF is configured for the VFL configuration identifier for the analytic identifier;
sending a service response, wherein the service response indicates the candidate NWDAF using a temporary identifier and one or more of the LM identifier or the feature identifier associated with the VFL configuration identifier;
receiving a service request to initiate VFL training, the service request comprising the analytic identifier, the VFL configuration identifier, and a VFL correlation identifier that identifies the VFL training session between a VFL server and a VFL client; and
sending an indication that indicates that VFL training is complete to the candidate NWDAF, wherein the indication comprises the VFL correlation identifier.

12. The method of claim 11, further comprising assigning a VFL client identifier to the candidate NWDAF, wherein VFL client identifier is valid during a VFL training session between an Application Function (AF) and the candidate NWDA.

13. The method of claim 12, further comprising sending a service request for VFL client discovery from the AF, the service request comprising analytics service information comprising the analytic identifier and the VFL correlation identifier, and at least one of service area information or a time condition specific to a particular service area or time period.

14. The method of claim 11, further comprising:
receiving a service request for VFL client discovery comprising a VFL correlation identifier;
sending, based on the service request, a request for a list of candidate NWDAFs that are configured for the VFL configuration identifier for the analytic identifier; and
receiving the list of the candidate NWDAFs from Network Function (NF) profiles of the candidate NWDAFs upon an indication that the VFL correlation identifier is included in the NF profiles of the candidate NWDAFs.

15. The method of claim 14, further comprising requesting additional information from the NWDAFs identified from the NF profiles and to verify whether the additional information includes the VFL correlation identifier.

16. The method of claim 15, further comprising selecting the candidate NWDAF configured for the VFL correlation identifier based on the additional information received from each NWDAF, and assign a VFL client identifier to each selected NWDAF, wherein each VFL client identifier is valid for a VFL inference session between an Application Function (AF) and the selected NWDAFs, and wherein each VFL client identifier is used to anonymize the identification information of each NWDAF from the AF.

17. The method of claim 11, further comprising determining intermediate model training results comprising at least one of gradient information or loss information from the candidate NWDAF.

18. The method of claim 11, further comprising:
receiving a service request for VFL client discovery that comprises a VFL correlation identifier for an analytic identifier;
sending a request for a list of NWDAFs from the plurality of NWDAFs that are configured for a configuration identifier for the analytic identifier; and
receiving the list of NWDAFs that are configured for the VFL configuration identifier for the analytic identifier based on the VFL correlation identifier.

19. The method of claim 11, further comprising sending an additional service response for VFL client discovery, the additional service response comprising a list of candidate NWDAFs represented by temporary identifiers and additional information for each of the candidate NWDAFs, the additional information comprising one or more of an LM identifier or a feature identifier.

20. The method of claim 19, further comprising selecting one or more candidate NWDAFs from the list of candidate NWDAFs based on at least one of the LM identifier or the feature identifier from the additional information for the each of the candidate NWDAFs to perform VFL inference using a trained machine learning model associated with the VFL correlation identifier.
